(19) United States
(12) Patent Application Publication
(10) Pub. No.: US 2006/0209967 A1
(43) Pub. Date: Sep. 21, 2006

(54) Method for the Reconstruction of Zero Crossing Information of Noisy Angle-Modulated Signals Following Limiter-Discriminator Signal Processing

(76) Inventor: Jurgen Niederholz, Kerken (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/276,720

(22) Filed: Mar. 10, 2006

Related U.S. Application Data
(63) Continuation of application No. PCT/DE04/01824, filed on Aug. 16, 2004.

(30) Foreign Application Priority Data
Sep. 12, 2003 (DE) 103 42 193.9

(51) Int. Cl. H04B 14/04

(52) U.S. Cl. 375/254

(57) ABSTRACT

In a method for generating a reduced-noise signal sequence {\hat{t}ᵢ} from a noisy signal sequence {uⱼ} comprising values uⱼ which are characteristic of the temporal position of crossings of a noisy angle-modulated signal through a threshold value, a decision is made (102) as to whether a value \hat{t}ᵢ of the reduced-noise signal sequence is to be generated for the value uⱼ. If this is the case, the value \hat{t}ᵢ is calculated taking into account earlier values uⱼ of the noisy signal sequence for which no values of the reduced-noise signal sequence {\hat{t}ᵢ} were generated.

### CROSS-REFERENCE TO RELATED APPLICATION

This application is a continuation of co-pending International Application No. PCT/DE2004/001824 filed Aug. 16, 2004 which designates the United States, and claims priority to German application number DE 103 42 193.9 filed Sep. 12, 2003.

### TECHNICAL FIELD

The invention relates to a method and an apparatus for generating a reduced-noise signal sequence from a noisy signal sequence comprising values which are characteristic of the temporal position of crossings of a noisy angle-modulated signal through a threshold value.

### BACKGROUND

Receiver concepts which make it possible to estimate the transmitted digital data symbols of CPFSK-modulated (Continuous Phase Frequency Shift Keying) or angle-modulated signals on the basis of a sequence of zero crossings are used, in particular, in the field of mobile radio technology. In this case, this zero crossing sequence is derived from the output signal of a limiter having a downstream counting discriminator. The concept of using a zero crossing sequence to detect data is interesting from the point of view of complexity and cost, in particular, since it makes it possible to dispense with an (expensive) analog/digital converter.

The document DE 102 14 581.4, which was not yet published on the application date of the present property right, discloses an intermediate frequency receiver which uses a zero crossing detector to detect signals. To this end, the sequence of zero crossing intervals which is output by the limiter-discriminator is stored in digital form in a shift register chain and is compared with previously stored zero crossing reference sequences in a classification unit. Data detection on the basis of the sequence of zero crossing intervals is effected in such a manner that that previously stored zero crossing reference sequence which is at the shortest distance from the measured zero crossing sequence is selected. The symbol or symbols corresponding to this selected zero crossing reference sequence represent(s) the detected symbol or symbols.

One difficulty with these receiver concepts which are based on the evaluation of a measured zero crossing sequence is that additive channel noise has an effect on the zero crossing sequence, to be precise, inter alia, in such a manner that additional zero crossings are produced. These additional zero crossings constitute interference which has a disadvantageous effect on the performance of each detection method that evaluates the zero crossing sequence. Irrespective of the type of data detector that is connected downstream of the limiter-discriminator, it is therefore desirable to eliminate those zero crossings in the zero crossing sequence which can be attributed to noise.

One possible way of suppressing the additional zero crossings (caused by noise) in the zero crossing sequence is to sample the bivalent signal that is output by the limiter and to eliminate the rapid edge changes (caused by noise) in this signal by means of filtering. Counting discrimination does not take place in this case. The disadvantage is that it becomes necessary to sample the signal that has been limited. It can also be shown that (linear) filtering, in principle, does not make it possible to optimally suppress noise in a signal that is generated by a limiter.

### SUMMARY

The invention is based on the object of specifying a method and an apparatus for generating a reduced-noise threshold value crossing signal sequence from a noisy threshold value crossing signal sequence, in which method and apparatus the threshold value crossings which are caused by noise are eliminated to the greatest possible extent or are eliminated completely.

The formulated object on which the invention is based can be achieved by a method for generating a reduced-noise signal sequence from a noisy signal sequence comprising values which are characteristic of the temporal position of crossings of a noisy angle-modulated signal through a threshold value, said method having the following steps:
(a) making a decision as to whether a value of the reduced-noise signal sequence is to be generated for a value of the noisy signal sequence;
(b) if a value of the reduced-noise signal sequence is to be generated for the value of the noisy signal sequence, then updating the reduced-noise signal sequence by means of a new value, wherein this value of the reduced-noise signal sequence is calculated taking into account earlier values of the noisy signal sequence for which no values of the reduced-noise signal sequence were generated.

Step (a) may have the following steps:
comparing the value of the noisy signal sequence with a decision threshold value;
   if the value of the noisy signal sequence is greater than the decision threshold value, a decision is made that a value of the reduced-noise signal sequence is to be generated for said value; otherwise
   a decision is made that no value of the reduced-noise signal sequence is to be generated for said value.

Step (b) may comprise the following steps:
(b1) the current value u; of the noisy signal sequence is stored, said value being greater than the decision threshold value;
(b2) the value \hat{t}ᵢ of the reduced-noise signal sequence is calculated from previous values uⱼ₋₁, uⱼ₋₂, . . . , u_{j-B} of the noisy signal sequence and from a value a₀ which results, according to a prescribed computation rule, from that value u_{j-B-1} of the noisy signal sequence which occurred last and is greater than the decision threshold value, B indicating the number of values of the noisy signal sequence between the current value uⱼ and that value u_{j-B-1} of the noisy signal sequence which occurred last and exceeds the threshold value; and
(b3) the value a₀ is updated according to the prescribed computation rule.

In step (b2), the value \hat{t}ᵢ of the reduced-noise signal sequence can be calculated according to the following relationship

$${\hat{t}}_{i} = \{ \begin{matrix}{a}_{0} , & B = 0 \\ {a}_{0} + {b}_{0} , & B = 2 \\ {a}_{0} + {b}_{0} + … + {b}_{( B / 2 ) - 2} + \frac{{b}_{( B / 2 ) - 1} + {b}_{( B / 2 )}}{2} , & B > 2\end{matrix} ,$$

where b₀ to b_{B-1} denote the previous values u_{j-B} to uⱼ₋₁, and wherein the computation rule used in step (b3) to update the value a₀ is:

$${a}_{0} = \{ \begin{matrix}{a}_{1} , & B = 0 \\ {a}_{1} + {b}_{B - 1} , & B = 2 \\ {a}_{1} + \frac{{b}_{( B / 2 ) - 1} + {b}_{( B / 2 )}}{2} + {b}_{( B / 2 ) + 1} + … + {b}_{B - 1} , & B > 2\end{matrix} .$$

The noisy signal sequence can be generated from the noisy angle-modulated signal using a limiter-discriminator circuit. The angle-modulated signal can be a CPFSK-modulated signal, in particular a GFSK-modulated signal. The method can be used in Bluetooth or DECT systems.

The object can also be achieved by an apparatus for generating a reduced-noise signal sequence from a noisy signal sequence comprising values which are characteristic of the temporal position of crossings of a noisy angle-modulated signal through a threshold value, said apparatus comprising means for deciding whether a value of the reduced-noise signal sequence is to be generated for a value of the noisy signal sequence; a means for calculating said value of the reduced-noise signal sequence taking into account earlier values of the noisy signal sequence for which no values of the reduced-noise signal sequence were generated, and means for updating the reduced-noise signal sequence by means of the calculated value.

The decision means may comprise a threshold value comparator which compares the values of the noisy signal sequence with a decision threshold value, in which case, if the value of the noisy signal sequence is greater than the decision threshold value, a value of the reduced-noise signal sequence is to be generated for said value, and, otherwise, no value of the reduced-noise signal sequence is to be generated for said value. The apparatus may further comprise a limiter-discriminator circuit for generating the noisy signal sequence from the noisy angle-modulated signal.

According to an embodiment, in a first step (a), a decision is made as to whether a value of the reduced-noise signal sequence is to be generated for a value of the noisy signal sequence. It is thus determined whether the considered value of the noisy signal sequence can be attributed to noise or whether it corresponds to a regular threshold value crossing of the angle-modulated signal. In a second step (b), the reduced-noise signal sequence is updated by means of a new value if a value of the reduced-noise signal sequence is to be generated for the value of the noisy signal sequence. This value of the reduced-noise signal sequence is calculated taking into account earlier values of the noisy signal sequence for which no values of the reduced-noise signal sequence were generated.

In the case of the invention, the signal which has been limited and discriminated is thus freed from noise using a further signal processing process. According to step (a), this signal processing process is based on non-linear mapping of the noisy signal sequence to the reduced-noise signal sequence or the signal sequence which has been freed from noise. The inventive algorithm thus takes into account the specific effect of the non-linearity of the limiter on the phase-modulated signal. Furthermore, according to step (a), the signal sequence from which the noise has been removed has the same number of values as the ideal signal sequence which would be generated without noise by means of the angle-modulated signal. In step (b), the effect of the noise is then taken into account when calculating the values of the reduced-noise signal sequence.

Step (a) is preferably carried out in such a manner that the values of the noisy signal sequence are compared with a decision threshold value. If the value of the noisy signal sequence is greater than the decision threshold value, a decision is made that a value of the reduced-noise signal sequence is to be generated for said value. Otherwise, a decision is made that no value of the reduced-noise signal sequence is to be generated for said value. In this case, the threshold value should be chosen in such a manner that it makes it possible to reliably distinguish between values of the noisy signal sequence which are caused by noise and regular values of the noisy signal sequence.

The angle-modulated signal is preferably a CPFSK-modulated signal, in particular a GFSK-modulated (Gaussian Frequency Shift Keying) signal. These forms of modulation are used in Bluetooth or DECT systems in which the inventive method is preferably used.

The inventive apparatus which is intended to generate a reduced-noise signal sequence and is preferably connected downstream of a limiter-discriminator circuit has a means for deciding whether a value of the reduced-noise signal sequence is to be generated for a value of the noisy signal sequence. The apparatus also comprises a means for calculating said value of the reduced-noise signal sequence taking into account earlier values of the noisy signal sequence for which no values of the reduced-noise signal sequence were generated, and a means for updating the reduced-noise signal sequence by means of the calculated value. This “de-noising” signal processing stage frees a sequence of threshold value crossings, in a non-linear manner, from threshold value crossings which are induced by noise.

### BRIEF DESCRIPTION OF THE DRAWINGS

The invention is explained in more detail below using an exemplary embodiment and with reference to the drawings, in which:

FIG. 1 shows a model of the transmission system comprising a transmitter, a channel and a receiver without the inventive apparatus for reducing noise;

FIG. 2 shows part of the model illustrated in FIG. 1, said part representing the receiver end and having an inventive apparatus for reducing noise;

FIG. 3 shows a graph in which a noiseless and a noisy CPFSK-modulated intermediate frequency signal are illustrated against time;

FIG. 4 shows a detail from FIG. 3;

FIG. 5 shows a graph in which the zero crossing intervals of the noiseless intermediate frequency signal shown in FIG. 3 are illustrated against the counting index j;

FIG. 6 shows a graph in which the zero crossing intervals of the noisy intermediate frequency signal shown in FIG. 3 are illustrated against the counting index j;

FIG. 7 shows a standardized histogram for illustrating the probability density function pᵤ(x) of the noiseless CPFSK-modulated intermediate frequency signal;

FIG. 8 shows a standardized histogram for illustrating the probability density function pᵤ(x) of the noisy CPFSK-modulated intermediate frequency signal; and

FIG. 9 shows a flowchart of the inventive algorithm for reducing noise.

### DETAILED DESCRIPTION

FIG. 1 shows a model of an angle-modulating transmission system. At the transmitter end, the data symbol sequence {dₖ} to be transmitted is supplied to a modulator 1. Suitable modulation, for example CPFSK modulation, is carried out in the modulator 1. The phase function Φ_{T}(t) provided by the modulator 1 is supplied to a radio-frequency section 2 of the transmitter. The radio-frequency section 2 emits a real-value radio-frequency signal (x)t via an antenna (not illustrated), A_{T} being used to denote the signal amplitude and ω₀ being used to denote the carrier frequency in FIG. 1.

The radio-frequency signal x(t) is transmitted via a multipath channel 3 which may be assumed to be spectrally and temporally free from dispersion. The transmission response of the multipath channel 8 is indicated by the pulse response g(t). In addition, additive channel noise (represented by the function n(t)) is superimposed on the transmitted radio-frequency signal.

The received signal r(t) which is received by a radio-frequency section 4 at the receiver end via an antenna (not illustrated) results from convolution of the pulse response g(t) with the emitted signal x(t) plus the noise contribution n(t). In the radio-frequency section 4 of the receiver, this signal is down-mixed to form an intermediate frequency signal y(t). In this case, in FIG. 1, A denotes the amplitude of the intermediate frequency signal, ω_{IF} denotes the angular frequency of the intermediate frequency signal, Φ(t) denotes the phase function and n_{Φ}(t) denotes a phase noise contribution of this signal.

The intermediate frequency signal y(t) is received by a detector for zero crossings 5, said detector comprising a limiter 6 and a counter 7 that is connected downstream of the limiter 6. The limiter 6 generates a bivalent signal, for instance in such a form that the limiter output assumes the value 1 if y(t)>0 and assumes the value −1 if y(t)<0. Zero crossings of the intermediate frequency signal y(t) thus correspond to zero crossings of the signal at the output of the limiter 6, the transfer function of the limiter obviously being non-linear.

The counter 7 uses the output signal of the limiter to generate a sequence {\hat{t}ᵢ} of values \hat{t}ᵢ which are characteristic of the temporal position of the zero crossings of the intermediate frequency signal y(t). This may be effected, for example, by the counter 7 outputting the temporal intervals between successive zero crossing times as values \hat{t}ᵢ. To this end, a counting frequency f₀ which is considerably higher than the expected frequency of the zero crossings of the intermediate frequency signal y(t) is supplied to the counter 7. The counter 7 is reset to the value zero by each edge of the output signal of the limiter 6, the previously reached counter reading being output as the zero crossing interval \hat{t}ᵢ. Other forms of generating zero crossing information—for example by means of continuous counting together with outputting of the count values at zero crossings and resetting of the counter, for example at the symbol clock rate—are likewise possible.

The sequence of zero crossing intervals {\hat{t}ᵢ} determined in this manner is supplied to a data detector 8 which reconstructs the transmitted data in the form of the sequence {\hat{d}ᵢ} on the basis of the sequence {\hat{t}ᵢ}.

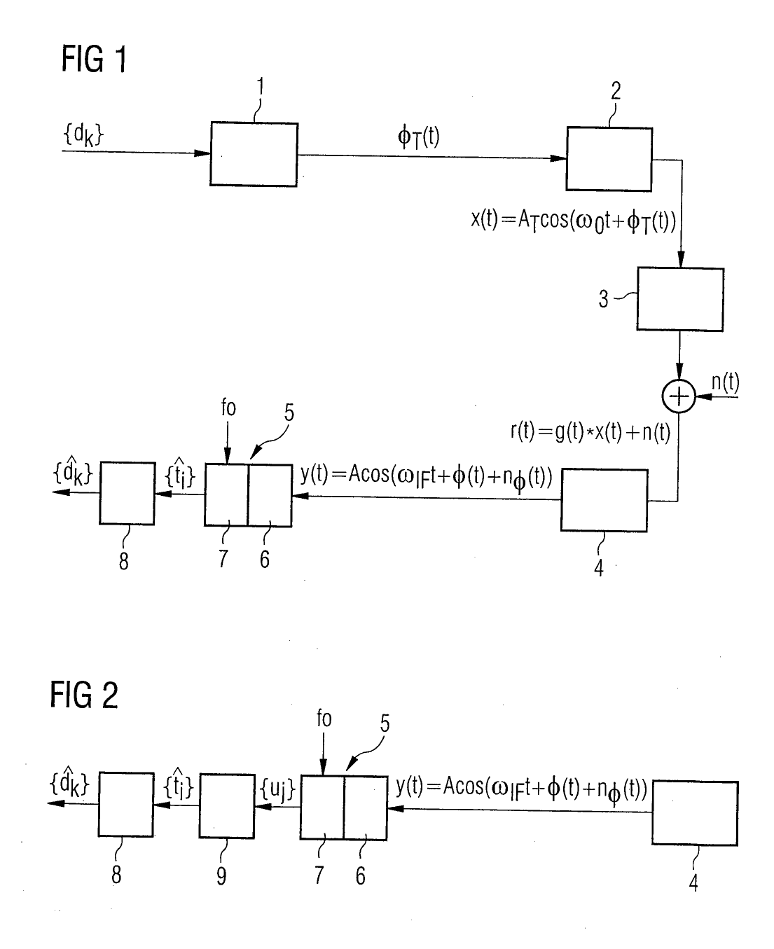

FIG. 2 shows the receiver-end part of the signal processing (illustrated in FIG. 1) according to the invention. The same reference symbols are used to denote the same parts as in FIG. 1. An additional signal processing stage in the form of a noise reduction circuit 9 is arranged between the output of the detector 5 for zero crossings and the input 8 of the data detector.

It is pointed out that the noise reduction circuit 9 can be used for any desired data detectors 8 which process zero crossing sequences (or more generally: threshold value crossing sequences) as an input signal.

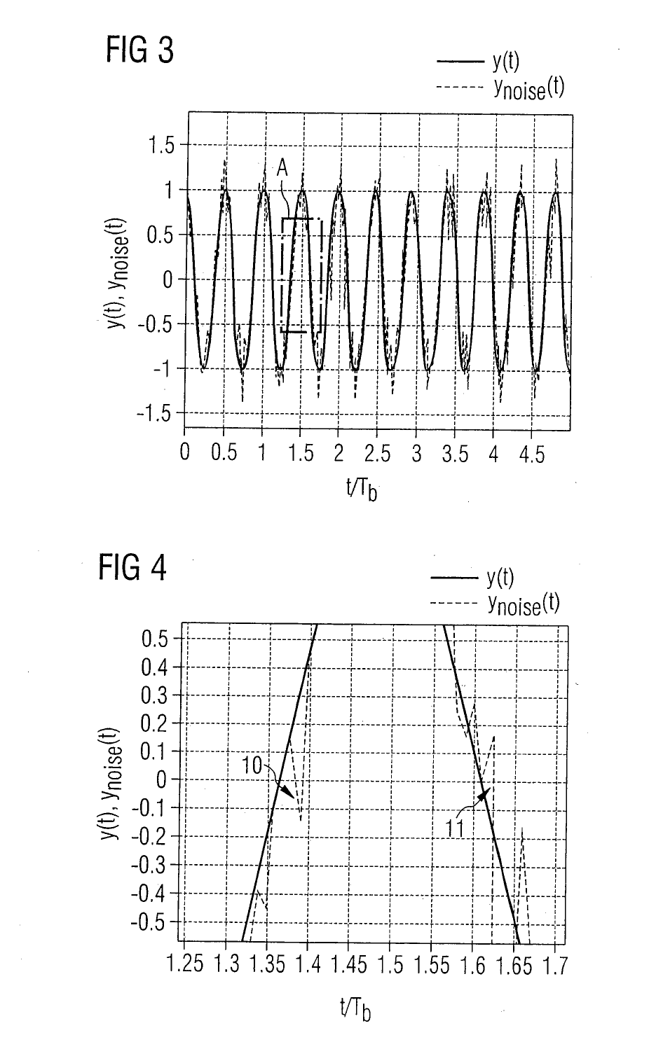

The sequence {uⱼ} indicates the sequence of zero crossing intervals which is output by the detector 5 for zero crossings. Said sequence contains both the regular zero crossing intervals and zero crossing intervals which are caused by the additive noise n(t). The effect of the additive noise n(t) on the occurrence of (additional) zero crossing intervals is explained in FIGS. 3 to 8.

FIG. 3 shows the noiseless CPFSK-modulated intermediate frequency signal y(t) and the noisy CPFSK-modulated intermediate frequency signal Yₙₒᵢₛₑ(t) plotted against time t in units of the symbol duration (bit duration) T_{b}.

FIG. 4 shows the effect of the noise on the occurrence of zero crossings. As regards the rising signal edge, two further zero crossings which are generated by a noise spike that reduces the signal also occur, in addition to the regular zero crossing, at the reference symbol 10. As regards the falling signal edge, only one zero crossing which has been shifted to higher times by a noise spike that increases the signal occurs at the reference symbol 11. In principle, two possible noise effects thus occur: either new zero crossings arise or the zero crossing is shifted.

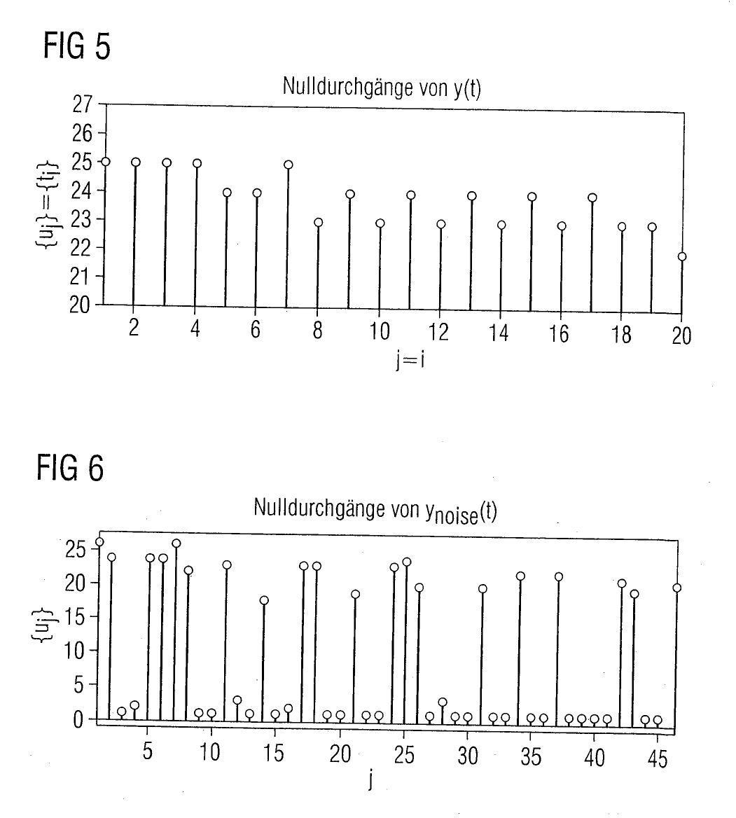

In FIGS. 5 and 6, the zero crossing intervals (counter readings) uⱼ are plotted against the index j of the zero crossing. FIG. 5 relates to the noise-free situation, i.e. {uⱼ}={tᵢ}, where {tᵢ} is used to denote the sequence of noise-free zero crossing intervals. FIG. 6 shows that the additive noise contribution n(t) results in additional zero crossings with short intervals in the noisy sequence of zero crossing intervals {uⱼ}.

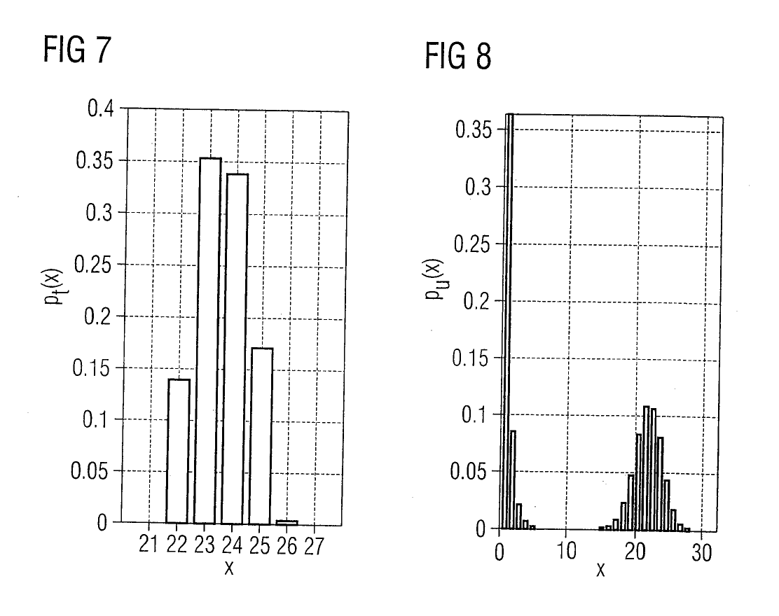

FIGS. 7 and 8 illustrate the corresponding frequency distributions as estimates of the probability density functions of noiseless and noisy CPFSK-modulated intermediate frequency signals. FIG. 7 relates to the case of a noiseless intermediate frequency signal having the probability density function pₜ(x). FIG. 8 shows the probability density function pᵤ(x) of a noisy CPFSK-modulated intermediate frequency signal. The variable x indicates the interval (count value of the counter 7) between two successive zero crossings. It becomes clear that the additive noise contribution results in a large number of short zero crossing intervals in the range of approximately 1 to 5 count values and in widening of the probability density function in the region of the regular zero crossing intervals.

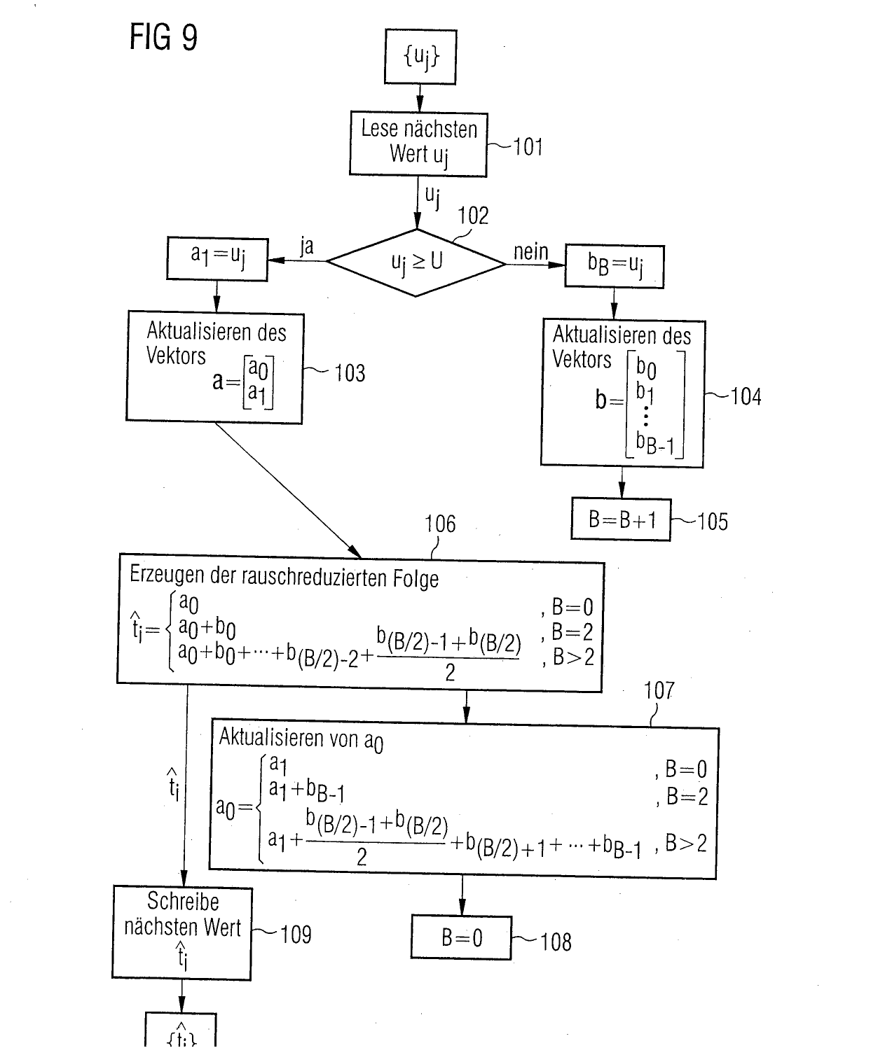

FIG. 9 shows a flowchart of the inventive method for calculating the zero crossing sequence {\hat{t}ᵢ}—which has been freed from noise—from the noisy zero crossing sequence {uⱼ}. The method is based on the hypothesis (supported by FIG. 8) that the probability density function pᵤ(x) of the sequence {uⱼ} is bimodal. It is assumed that values (i.e. zero crossing intervals) above a threshold value U have only been lengthened or shortened by the effect of noise. According to the hypothesis, values below this threshold value U can be attributed to additional zero crossings which are caused by noise.

For this signal modeling, assumptions are made which can be effectively fulfilled by customary receiver front ends with a very acceptable level of complexity. The intermediate frequency to which the received signal is down-mixed before limiting is thus chosen, taking into account the modulation shift and a “worst-case” signal-to-noise ratio, in such a manner that the abovementioned hypothesis applies with a good degree of accuracy. The worst-case signal-to-noise ratio is understood as meaning that signal-to-noise ratio which is needed to achieve the required (practically expedient, minimum) bit error rate.

In a first step 101, the next value uⱼ is received or read by the counter 7. In step 102, a decision is made as to whether or not a value of the output sequence {\hat{t}ᵢ} is to be generated for said value uⱼ. To this end, the value uⱼ is compared with the decision threshold value U. If uⱼ≧U, the value uⱼ is entered, as component a₁, in a [2×1] vector a (step 103). Otherwise, uⱼ is entered, as the last element b_{B}=uⱼ, in a [B×1] vector b (see step 104). In step 105, B is then incremented by 1. The vector b thus stores those zero crossing intervals which, according to the decision in step 102, can be attributed to noise.

A value \hat{t}ᵢ of the sequence {\hat{t}ᵢ} from which the noise has been removed is calculated, in step 106, according to the following equation

$${\hat{t}}_{i} = \{ \begin{matrix}{a}_{0} , & B = 0 \\ {a}_{0} + {b}_{0} , & B = 2 \\ {a}_{0} + {b}_{0} + … + {b}_{( B / 2 ) - 2} + \frac{{b}_{( B / 2 ) - 1} + {b}_{( B / 2 )}}{2} , & B > 2\end{matrix} .$$

This equation takes into account the fact that the number of zero crossings between two regular zero crossings must always be odd under said hypothesis. Therefore, B is always an even integer.

The vector element a₀ is then recalculated (step 107) in accordance with

$${a}_{0} = \{ \begin{matrix}{a}_{1} , & B = 0 \\ {a}_{1} + {b}_{B - 1} , & B = 2 \\ {a}_{1} + \frac{{b}_{( B / 2 ) - 1} + {b}_{( B / 2 )}}{2} + {b}_{( B / 2 ) + 1} + … + {b}_{B - 1} , & B > 2\end{matrix}$$

and B=0 is set (step 108). In step 109, the recalculated value \hat{t}ᵢ is output at the output of the noise reduction circuit 9.

The cycle which is illustrated in FIG. 9 is thus concluded. In the next cycle, the next value uⱼ of the noisy sequence of zero crossing intervals {uⱼ} is read in.

One advantage of the algorithm illustrated in FIG. 9 is that the signal sequence {\hat{t}ᵢ} from which the noise has been removed has the same number of zero crossings as the noiseless signal sequence {\hat{t}ᵢ}. This is important for many detection methods since additional zero crossings in the signal sequence on which data detection is based may result in detection errors. Another advantage is that the signal sequence {\hat{t}ᵢ} which has been generated corresponds better to the ideal (noiseless) signal sequence {\hat{t}ᵢ} than the original zero crossing sequence {uⱼ} on account of the noise reduction. Those detection methods, in particular, which reconstruct the noiseless signal on the basis of the zero crossing intervals benefit from this.

As already mentioned, the inventive method is superior to conventional filter-based approaches on account of the principle. The reason for this is that the inventive method uses specific statistical relationships (which are produced as a result of the effect of the limiter non-linearity on the phase-modulated signal) between the zero crossing intervals, which relationships cannot be taken into account, in principle, by filtering.

What is claimed is:

1. A method for generating a reduced-noise signal sequence from a noisy signal sequence comprising values which are characteristic of the temporal position of crossings of a noisy angle-modulated signal through a threshold value, said method having the following steps:
(a) making a decision as to whether a value of the reduced-noise signal sequence is to be generated for a value of the noisy signal sequence;
(b) if a value of the reduced-noise signal sequence is to be generated for the value of the noisy signal sequence, then updating the reduced-noise signal sequence by means of a new value, wherein this value of the reduced-noise signal sequence is calculated taking into account earlier values of the noisy signal sequence for which no values of the reduced-noise signal sequence were generated.

2. A method as claimed in claim 1, wherein step (a) has the following steps:
comparing the value of the noisy signal sequence with a decision threshold value;
if the value of the noisy signal sequence is greater than the decision threshold value, a decision is made that a value of the reduced-noise signal sequence is to be generated for said value; otherwise
a decision is made that no value of the reduced-noise signal sequence is to be generated for said value.

3. A method as claimed in claim 1, wherein step (b) comprises the following steps:
(b1) the current value uⱼ of the noisy signal sequence is stored, said value being greater than the decision threshold value;
(b2) the value \hat{t}ᵢ of the reduced-noise signal sequence is calculated from previous values uⱼ₋₁, uⱼ₋₂, . . . , u_{j-B} of the noisy signal sequence and from a value a₀ which results, according to a prescribed computation rule, from that value u_{j-B-1} of the noisy signal sequence which occurred last and is greater than the decision threshold value, B indicating the number of values of the noisy signal sequence between the current value uⱼ and that value u_{j-B-1} of the noisy signal sequence which occurred last and exceeds the threshold value; and
(b3) the value a₀ is updated according to the prescribed computation rule.

4. A method as claimed in claim 3, wherein in step (b2), the value \hat{t}ᵢ of the reduced-noise signal sequence is calculated according to the following relationship
$${\hat{t}}_{i} = \{ \begin{matrix}{a}_{0} , & B = 0 \\ {a}_{0} + {b}_{0} , & B = 2 \\ {a}_{0} + {b}_{0} + … + {b}_{( B / 2 ) - 2} + \frac{{b}_{( B / 2 ) - 1} + {b}_{( B / 2 )}}{2} , & B > 2\end{matrix} ,$$
where b₀ to b_{B-1} denote the previous values u_{j-B} to uⱼ₋₁, and wherein the computation rule used in step (b3) to update the value a₀ is:
$${a}_{0} = \{ \begin{matrix}{a}_{1} , & B = 0 \\ {a}_{1} + {b}_{B - 1} , & B = 2 \\ {a}_{1} + \frac{{b}_{( B / 2 ) - 1} + {b}_{( B / 2 )}}{2} + {b}_{( B / 2 ) + 1} + … + {b}_{B - 1} , & B > 2\end{matrix} .$$

5. A method as claimed in claim 1, wherein the noisy signal sequence is generated from the noisy angle-modulated signal using a limiter-discriminator circuit.

6. A method as claimed in claim 1, wherein the angle-modulated signal is a CPFSK-modulated signal, in particular a GFSK-modulated signal.

7. A method as claimed in claim 1, wherein the method is used in Bluetooth or DECT systems.

8. An apparatus for generating a reduced-noise signal sequence from a noisy signal sequence comprising values which are characteristic of the temporal position of crossings of a noisy angle-modulated signal through a threshold value, said apparatus comprising
a means for deciding whether a value of the reduced-noise signal sequence is to be generated for a value of the noisy signal sequence;
a means for calculating said value of the reduced-noise signal sequence taking into account earlier values of the noisy signal sequence for which no values of the reduced-noise signal sequence were generated, and
a means for updating the reduced-noise signal sequence by means of the calculated value.

9. An apparatus as claimed in claim 8, wherein the decision means comprises a threshold value comparator which compares the values of the noisy signal sequence with a decision threshold value, in which case, if the value of the noisy signal sequence is greater than the decision threshold value, a value of the reduced-noise signal sequence is to be generated for said value, and, otherwise, no value of the reduced-noise signal sequence is to be generated for said value.

10. An apparatus as claimed in claim 8, comprising a limiter-discriminator circuit for generating the noisy signal sequence from the noisy angle-modulated signal.

11. A system for generating a reduced-noise signal sequence from a noisy signal sequence comprising values which are characteristic of the temporal position of crossings of a noisy angle-modulated signal through a threshold value, comprising:
means for making a decision as to whether a value of the reduced-noise signal sequence is to be generated for a value of the noisy signal sequence;
means for updating the reduced-noise signal sequence with a new value, if a value of the reduced-noise signal sequence is to be generated for the value of the noisy signal sequence, wherein this value of the reduced-noise signal sequence is calculated taking into account earlier values of the noisy signal sequence for which no values of the reduced-noise signal sequence were generated.

12. A system as claimed in claim 11, further comprising:
means for comparing the value of the noisy signal sequence with a decision threshold value;
means for making a decision that a value of the reduced-noise signal sequence is to be generated for said value if the value of the noisy signal sequence is greater than the decision threshold value, and otherwise the means decide whether no value of the reduced-noise signal sequence is to be generated for said value.

13. A system as claimed in claim 11, further comprising:
means for storing the current value uⱼ of the noisy signal sequence, said value being greater than the decision threshold value;
means for calculating the value \hat{t}ᵢ of the reduced-noise signal sequence from previous values uⱼ₋₁, uⱼ₋₂, . . . , u_{j-B} of the noisy signal sequence and from a value a₀ which results, according to a prescribed computation rule, from that value u_{j-B-1} of the noisy signal sequence which occurred last and is greater than the decision threshold value, B indicating the number of values of the noisy signal sequence between the current value uⱼ and that value u_{j-B-1} of the noisy signal sequence which occurred last and exceeds the threshold value; and
means for updating the value a₀ according to the prescribed computation rule.

14. A system as claimed in claim 13, wherein the means for calculating calculate the value \hat{t}ᵢ of the reduced-noise signal sequence according to the following relationship
$${\hat{t}}_{i} = \{ \begin{matrix}{a}_{0} , & B = 0 \\ {a}_{0} + {b}_{0} , & B = 2 \\ {a}_{0} + {b}_{0} + … + {b}_{( B / 2 ) - 2} + \frac{{b}_{( B / 2 ) - 1} + {b}_{( B / 2 )}}{2} , & B > 2\end{matrix} ,$$
where b₀ to b_{B-1} denote the previous values u_{j-B} to uⱼ₋₁, and in that the computation rule used in step (b3) to update the value a₀ is:
$${a}_{0} = \{ \begin{matrix}{a}_{1} , & B = 0 \\ {a}_{1} + {b}_{B - 1} , & B = 2 \\ {a}_{1} + \frac{{b}_{( B / 2 ) - 1} + {b}_{( B / 2 )}}{2} + {b}_{( B / 2 ) + 1} + … + {b}_{B - 1} , & B > 2\end{matrix} .$$

15. A system as claimed in claim 11, further comprising:
means for generating the noisy signal sequence from the noisy angle-modulated signal using a limiter-discriminator circuit.

16. A system as claimed in claim 11, wherein the angle-modulated signal is a CPFSK-modulated signal, in particular a GFSK-modulated signal.

17. A system as claimed in claim 11, wherein the method is used in Bluetooth or DECT systems.
